(19) United States
(12) Patent Application Publication
(10) Pub. No.: US 2009/0014914 A1
(43) Pub. Date: Jan. 15, 2009

(54) Carbon dioxide supply for injection-molding systems

(76) Inventor: Andreas Praller, Germering (DE)

Correspondence Address: The BOC Group, Inc., 575 MOUNTAIN AVENUE, MURRAY HILL, NJ, 07974-2082, US

(21) Appl. No.: 11/794,408

(22) PCT Filed: Jan. 10, 2006
(86) PCT No.: PCT/EP06/00143

§ 371 Date: Mar. 19, 2008

(30) Foreign Application Priority Data
Jan. 21, 2005 (DE) 102005002976.0

(51) Int. Cl. B29C 45/57; F17C 13/02; B67D 5/02; B67D 5/63

(52) U.S. Cl. 264/328.14; 222/53; 222/54; 222/372

(57) ABSTRACT

To supply a consumer (13a, 13b) with liquid carbon dioxide with a desired temperature of more than 0° C. and a desired pressure of more than 30 bar, liquid carbon dioxide is taken from a tank (1) in which it is stored at a temperature below the desired temperature and a pressure below the desired pressure. The pressure of the carbon dioxide is increased (3) and subsequently the carbon dioxide is heated to the desired temperature (14a, 14b).

The invention relates to a method for the supply of a consumer with liquid carbon dioxide with a desired temperature of more than 0° C. and a desired pressure of more than 30 bar. In addition, the invention relates to a device for the supply of a consumer with liquid carbon dioxide under the mentioned conditions.

For cooling injection moulds or injection moulds carbon dioxide is also employed inter alia. To this end, capillary tubes or expansion nozzles are supplied with liquid, bubble-free carbon dioxide which expands in the capillary tubes and extracts heat from the injection mould in the process.

For even and reproducible cooling it is essential that the carbon dioxide is supplied to the tool with a certain desired pressure between 40 and 70 bar and a fixed desired temperature in the region of the ambient temperature. Maintaining the “warm” temperature range is required in order to avoid condensation of air humidity on the lines carrying carbon dioxide and on the injection moulds. For moisture or dripping water, which drips in the injection moulds, influences the quality of the produced moulded parts and holds the risk that the tools corrode.

Carbon dioxide with the mentioned pressure and temperature characteristics is usually taken from a so-called intermediate pressure tank in which the carbon dioxide is already stored in the desired pressure range from approximately 50 to 70 bar and the corresponding boiling temperature of 15 to 25° C. The liquid carbon dioxide is directed from the intermediate pressure tank to one or several injection moulds via pipelines.

Cooling of the tools is normally controlled and set via the clocking of a solenoid valve in the line to the injection mould. For reproducible cooling it is necessary that the pressure and the temperature of the carbon dioxide before the solenoid valve are always identical in size. If, for example in summer, the temperature in the production hall is higher than the boiling temperature corresponding to the tank pressure, the carbon dioxide partially can evaporate even in the pipeline connecting the intermediate pressure tank with the tool resulting in poorer and more uneven cooling.

The object of the present invention therefore is to make available a method and a corresponding device for the supply of a consumer with liquid carbon dioxide wherein the above mentioned problems are avoided.

This object is solved through a method of the type mentioned at the outset, wherein the carbon dioxide is taken from a tank in which the liquid carbon dioxide is stored at a temperature below the desired temperature and a pressure below the desired pressure, that the pressure of the carbon dioxide is increased and that subsequently the carbon dioxide is heated to the desired temperature.

The device according to the invention for the supply of a consumer with liquid carbon dioxide with a desired temperature of more than 0° C. and a desired pressure of more than 30 bar is characterized by the following features:
A tank in which the liquid carbon dioxide is stored at a temperature below the desired temperature and a pressure below the desired pressure,
A supply line connecting the tank with the consumer,
A pressure boosting apparatus in order to increase the pressure of the carbon dioxide supplied to the consumer and
A heater arranged downstream of the pressure boosting apparatus in order to heat the carbon dioxide.

According to the invention, liquid carbon dioxide is taken from a tank in which it is stored at a pressure below the required desired pressure and at a temperature below the desired temperature. The liquid carbon dioxide is then, preferably in the immediate proximity of the tank, supplied to a pressure boosting apparatus by means of which the pressure of the carbon dioxide is increased, namely preferentially to the desired pressure. Through the pressure increase according to the invention the carbon dioxide is super-cooled, i.e. the temperature of the carbon dioxide is below the boiling temperature corresponding to the increased pressure. As a result, the carbon dioxide does not evaporate during onward transport to the consumer and remains in the liquid state. As close as possible to the consumer the carbon dioxide is then heated to the desired temperature and supplied to the consumer in liquid form. The method according to the invention ensures that en route from the tank to the consumer no carbon dioxide evaporates and liquid carbon dioxide is always available at the consumer.

Preferably the carbon dioxide is taken from a low-pressure tank with a pressure between 10 and 30 bar and a corresponding boiling temperature of approximately −40° C. to −10° C. Particularly preferably a low-pressure tank with a pressure between 14 and 25 bar is used. The pressure of the carbon dioxide is then preferably increased to 40 to 90 bar, particularly preferably 50 to 70 bar.

A pneumatically or hydraulically driven compressor is preferably used as pressure boosting apparatus. In this way it is made possible, after the pressure increase, to direct the carbon dioxide to the consumer directly via a tie line without a part of the carbon dioxide having to be directed back into the tank or another pressure vessel or intermediate tank. It is, however, likewise possible to employ an electrically driven compressor or a centrifugal or piston pump which require returning at least a part of the carbon dioxide into the tank.

Following the pressure increase the carbon dioxide is present in the highly super-cooled state, i.e. its temperature is significantly below the boiling temperature corresponding to the carbon dioxide pressure. Under these conditions no evaporation of liquid carbon dioxide takes place.

Before the pressure increase the carbon dioxide is in a state of equilibrium, i.e. not yet super-cooled. In this state carbon dioxide can evaporate with the appropriate heat supply. For this reason the pressure boosting apparatus is provided as closely as possible to the carbon dioxide tank. Preferably the line length between the tank and the pressure boosting apparatus is less than 2 metres, particularly preferably less than 1 metre.

Heating of the carbon dioxide preferably takes place to a temperature in the range from 5° C. to 25° C., particularly preferably from 10° C. to 20° C. The use of this approximately environment-warm temperature range has the advantage that condensation of air humidity on the consumer and the lines carrying the carbon dioxide is largely avoided. For the air humidity can be undesirable depending on the area of application. More preferably during the use of carbon dioxide for the cooling of injection moulds or injection moulds for instance moisture is to be avoided since this moisture can lead to corrosion on the tools or have negative effects on the surfaces of the injection moulded parts produced in the tools or moulds.

Heating of the liquid carbon dioxide must be carried out such that during the heating and en route from the heater to the consumer no evaporation takes place. Air evaporators, water evaporators or an electrically operated heater are heaters that can be considered. Preferentially for space reasons, because of the operational safety and the control accuracy, an electrically operated heater is employed. The heater is preferably arranged as closely as possible to the consumer.

The electrically operated heater is dimensioned so that no liquid carbon dioxide can evaporate even during intermittent operation. To this end it is an advantage to provide the heater with a metal block, preferably an aluminium block, in which the liquid carbon dioxide is carried. The temperature of the metal block is accurately controlled and so adapted to the pressure of the carbon dioxide that it always remains below the boiling temperature corresponding to the carbon dioxide pressure. In this manner evaporation of liquid carbon dioxide is prevented even in the time in which no carbon dioxide flows.

The invention is more preferably suitable for the supply of consumers with “warm” carbon dioxide at increased pressure. A preferred area of application is the temperature-regulation and cooling of injection moulds with liquid carbon dioxide, more preferably with carbon dioxide with a pressure of approximately 60 bar and a temperature of approximately 15° C. In addition, the method according to the invention for example can also be used for the supply of CO₂ expansion nozzles for the hollow body blowing or the internal extrusion cooling or generally with methods where carbon dioxide from a high pressure region of more than 50 bar is expanded for cooling purposes.

The invention as well as additional details of the invention are explained in more detail hereafter by means of the exemplary embodiments shown in the drawings. Here it shows

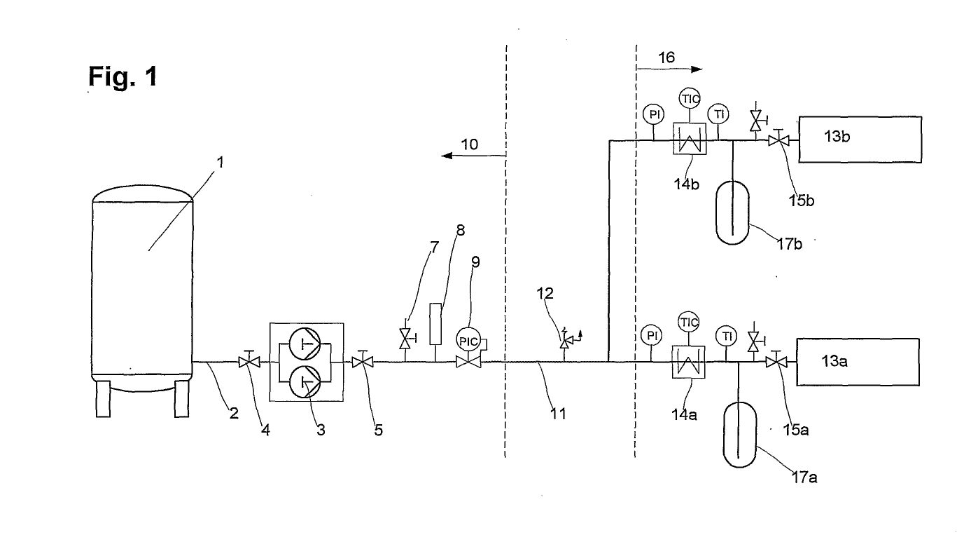

FIG. 1 a device according to the invention for the supply of extruders with liquid carbon dioxide and

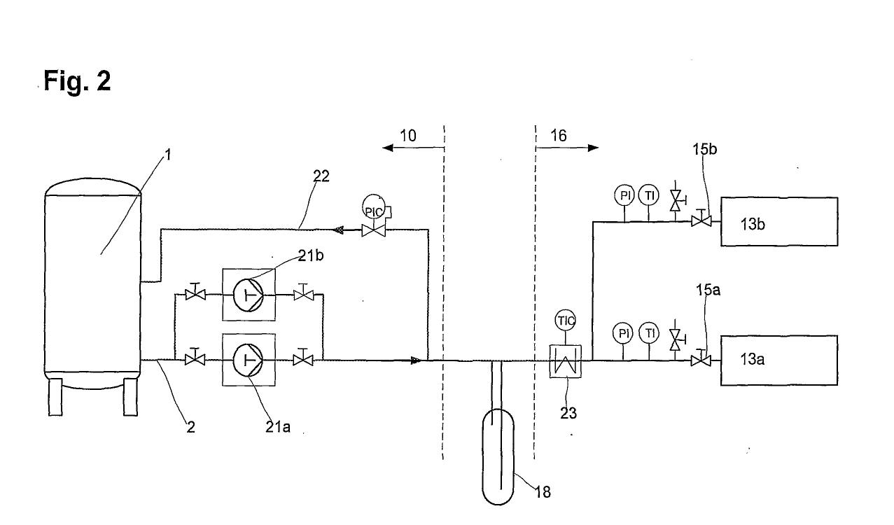

FIG. 2 an alternative embodiment of the supply concept shown in FIG. 1.

FIGS. 1 and 2 each shows a device for the supply of tools, more preferably injection moulds or machines with liquid carbon dioxide. The liquid carbon dioxide is required for the cooling of the injection moulds.

FIG. 1 shows a device which operates according to the method according to the invention. In a low-pressure tank 1 liquid carbon dioxide is stored under a pressure of 20 bar and a corresponding boiling temperature of approximately −20° C. The tank 1 is embodied as vacuum-insulated tank but can also be foam-insulated. At the lower end of the tank 1a tapping line 2 is provided via which the liquid carbon dioxide can be taken from the tank 1.

The tapping line 2 is followed by a compressor station 3. Before and behind the compressor station 3 valves 4, 5 are connected each. By means of the compressor station 3 the carbon dioxide drawn from the tank 1 is compressed to an increased pressure of 40 to 90 bar, preferentially 50 to 70 bar.

Downstream of the valves 5a, 5b the two lines a, b are re-joined into a common line. In the common line a vent valve 7, a settling tank 8 and a pressure regulator 9 are arranged in series.

The arrangement described so far can be summarized as tank-related installation 10. More preferably the compressor station 3 is located in the immediate proximity of the tank 1, i.e. the length of the tapping line 2 upstream of the compressor station 3 is kept very short, preferentially the length of the tapping line 2 amounts to less than 1 metre in order to prevent that liquid carbon dioxide evaporates in the tapping line 2 between tank 1 and the compressor station 3.

The tank-related installation 10 is followed by a high-pressure line 11 which is provided with a safety valve 12 and leads to the injection moulding machines 13a, 13b to be supplied with carbon dioxide. An electric heater 14a, 14b and a controllable solenoid valve 15a, 15b each are connected upstream of each of the injection moulding machines 13a, 13b.

The electric heaters 14a, 14b are dimensioned so that no liquid evaporates even during intermittent operation. This is achieved in that the liquid carbon dioxide is carried in a metal block, preferably an aluminium block, whose temperature is adapted to the carbon dioxide pressure after the compressor station 3. The temperature of the metal block is accurately controlled so that in the time in which no carbon dioxide flows no liquid carbon dioxide evaporates. In addition, the heaters 14a, 14b are arranged so closely to the injection moulding machines 13a, 13b that even after the heating, evaporation of the carbon dioxide prior to entry in the injection moulding machines 13a, 13b is excluded. The arrangement of the heaters 14a, 14b, the solenoid valves 15a, 15b and the associated measuring and control instruments can therefore be summarized as consumer-related installation 16.

The carbon dioxide taken from the tank 1 at a pressure of 20 bar and at a temperature of approximately −20° C. is then brought to an increased pressure of 40 to 90 bar, for example 60 bar, in the compressor station 3. The temperature of the carbon dioxide during compression however is increased only insignificantly so that the carbon dioxide is present in a highly super-cooled state, i.e. the temperature is clearly below the boiling temperature corresponding to the increased pressure.

In this super-cooled state the liquid carbon dioxide is supplied to the injection moulding machines 13a, 13b to be cooled. Owing to the high super-cooling, evaporation of liquid carbon dioxide during the transport through the high-pressure line 11 is excluded. The degree of super-cooling can be set via the compressor station 3 so that, even at higher ambient temperatures such as can occur for example in production halls in summer it is ensured that no carbon dioxide evaporates.

The super-cooled carbon dioxide is then brought to the desired temperature in the heaters 14a, 14b. For cooling or temperature-regulating of injection moulding machines 13a, 13b heating of the carbon dioxide to 15° C. has proved to be favourable.

The cooling of the injection moulding machines 13a, 13b is controlled via the clocking of the solenoid valves 15a, 15b. Through the method according to the invention liquid carbon dioxide with defined conditions, for example 60 bar and 15° C. is always available at the solenoid valves 15a, 15b. Reproducible even cooling of the injection moulding machines 13a, 13b even with fluctuating ambient temperatures is ensured in this fashion.

FIG. 2 shows an alternative embodiment of the invention where instead of the compressor station 3 pumps 21a, 21b are used. Otherwise identical components are provided with identical reference numbers in both FIGS. 1 and 2.

The liquid carbon dioxide with the arrangement according to FIG. 2 is preferentially stored in a foam-insulated storage tank 1 with re-cooling unit at a pressure of 20 bar and a corresponding boiling temperature of −20° C. Via the tapping line 2 liquid carbon dioxide is drawn from the tank 1 and supplied to one of two liquid pumps 21a, 21b arranged in parallel. Centrifugal or piston pumps are used as liquid pumps 21a, 21b. By means of the liquid pumps 21a, 21b the liquid carbon dioxide is compressed to a pressure of for example 60 bar.

Conventional liquid pumps 21a, 21b must always be supplied with liquid, here specifically with liquid carbon dioxide. It is therefore necessary to return the compressed carbon dioxide to the tank 1 via a ring line 22 in the circuit. Via the ring line 22 a carbon dioxide flow of such a magnitude has to be circulated that even with maximum consumption, i.e. when the solenoid valves 15a, 15b measure out the maximum carbon dioxide quantity to the injection moulding machines 13a, 13b, liquid carbon dioxide is still returned to the tank 1. The returned carbon dioxide is re-cooled before being directed into the tank 1.

If one of the two solenoid valves 15a, 15b which control the inflow of liquid carbon dioxide in the injection moulding machines 13a, 13b, compressed liquid carbon dioxide is supplied to a heater 23 and heated to the desired temperature of for example 15° C. or 20° C. The liquid carbon dioxide then enters the injection moulding machine 13a, 13b with the desired temperature and below the desired pressure of for example 60 bar.

The embodiment with only one heater 23 shown in FIG. 2 which supplies both injection moulding machines 13a, 13b can also be employed with the embodiment according to FIG. 1. Conversely, separate heaters for each line branch or for each injection moulding machine 13a, 13b can obviously be used with the arrangement according to FIG. 2.

1. A method for the supply of a consumer (13a, 13b) with liquid carbon dioxide with a desired temperature of more than 0° C. and a desired pressure of more than 30 bar, characterized in that the carbon dioxide is taken from a tank (1) in which the liquid carbon dioxide is stored at a temperature below the desired temperature and a pressure below the desired pressure, that the pressure of the carbon dioxide is increased (3, 21) and that subsequently the carbon dioxide is heated to the desired temperature (14a, 14b).

2. The method according to claim 1, characterized in that the pressure of the carbon dioxide is increased to 40 to 90 bar, preferably 50 to 70 bar.

3. The method according to any one of the claims 1 or 2, characterized in that carbon dioxide is heated to a temperature of 5° C. to 25° C., preferably 10° C. to 20° C.

4. The method according to any one of the claims 1 to 3, characterized in that the carbon dioxide is heated by means of an electrically operated heater (14a, 14b).

5. The method according to any one of the claims 1 to 4, characterized in that the carbon dioxide following the pressure increase (3) is directed to the consumer (13a, 13b) via a tie line (11).

6. The method according to any one of the claims 1 to 4, characterized in that following the pressure increase (21) a part of the carbon dioxide is redirected into the tank (1) and a part of the carbon dioxide is supplied to the consumer (13a, 13b).

7. The method according to any one of the claims 1 to 6, characterized in that an injection moulding machine (13a, 13b) is supplied with carbon dioxide.

8. A device for the supply of a consumer with liquid carbon dioxide with a desired temperature of more than 0° C. and a desired pressure of more 30 bar, characterized through
a tank (1) in which the liquid carbon dioxide is stored at a temperature below the desired temperature and a pressure below the desired pressure,
a supply line (11) connecting the tank (1) with the consumer (13a, 13b),
a pressure boosting apparatus (3, 21) to increase the pressure of the carbon dioxide supplied to the consumer and
a heater (14a, 14b) arranged upstream of the pressure boosting apparatus (3a, 3b) for heating the carbon dioxide.

9. The device according to claim 8, characterized in that the heat (14a, 14b) comprises a metal block through which the carbon dioxide is directed.

10. The device according to any one of the claims 8 or 9, characterized in that a hydraulically or pneumatically operated compressor is employed as pressure boosting apparatus (3).
